(19) United States
(12) Patent Application Publication
(10) Pub. No.: US 2004/0193289 A1
(43) Pub. Date: Sep. 30, 2004

(54) Decoding system and method

(76) Inventors: Shi Chen, San Jose, CA (US); Xuyun Chen, San Jose, CA (US); Christopher S. Maslyar, San Jose, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/743,850

(22) Filed: Dec. 22, 2003

Related U.S. Application Data
(60) Provisional application No. 60/437,229, filed on Dec. 31, 2002.

(51) Int. Cl. G05B 19/18

(52) U.S. Cl. 700/3

(57) ABSTRACT

A cost-effective decoding apparatus that balances the flexibility of the software and performance of the hardware is presented. The decoder includes a bus, hardware modules connected to the bus and configured to execute a decoding process, and a processing unit connected to the bus, wherein the processing unit executes a decoding process by sending programmed signals to the hardware modules and responding to interrupts from the hardware components according to a set of programmed instructions. The instructions are re-programmable. As the hardware modules are configured to execute discrete tasks, the decoding process may be carried out in its entirety by sending signals to the hardware modules in the programmed order. Also presented is a method of decoding data by establishing communication with hardware modules that are each configured to execute a discrete task and activating the hardware modules in an order dictated by a computer program is also presented.

### RELATED APPLICATION

This application claims the benefit, under 35 USC § 119(e), of U.S. Provisional Application No. 60/437,229 filed on Dec. 31, 2002.

### FIELD OF THE INVENTION

The present invention relates to a system and method for decoding compressed multimedia information. More specifically, the invention relates to a decoder architecture and method for coded video/audio data, such as data that complies with the Motion Picture Expert Group (MPEG-2) standard.

### BACKGROUND OF THE INVENTION

MPEG-2 is an international standard for encoding/decoding digital data, including digital video data, with tremendous efficiency. The MPEG-2 algorithm was standardized in the early 1990s by the International Standards Organization (ISO). Since then, MPEG-2 has been widely used in many applications including DVD Players, set-top boxes, and in Video On Demand (VOD) systems. It has become one of the most important and successful international standards in the digital multimedia field. Because of its complexity, the MPEG-2 decoding algorithm requires substantial computing power. A number of VLSI hardware implementations have been reported for decoding MPEG-2 video bitstreams. In recent years, with the development of VLSI technology, there is a trend to integrate the entire multimedia system into a single chip. A cost-effective MPEG-2 decoder core suitable for SOC (System On a Chip) integration is still the key technology for most multimedia systems.

An MPEG-2 bitstream is mainly composed of audio data, video data and other data time-multiplexed into a single stream. In the case of a DVD application for example, the bitstream is composed of MPEG-2 video data, audio data, subpicture data and navigation data. The main tasks involved in decoding an MPEG-2 bitstream are data de-multiplexing, MPEG-2 video decoding and AC3/DTS audio decoding. MPEG video bitstream decoding tasks includes variable length decoding (VLD), inverse quantization (IQ), applying an inverse discrete cosine transform (IDCT), and motion compensation (MC) as is well known. Audio decoding may include AC3, DTS or other audio forms.

An MPEG-2 decoder can be implemented using a general purpose CPU or a programmable DSP core (the processing unit) wherein the processing unit executes one or more software modules/routines that implement the decoding method. This software architecture is flexible and generally can implement a variety of different decoding methods since the software modules/routines being executed by the processing unit may be easily changed to handle different decoding methods. This software approach to decoding has been used in several VLSI implementations. However, this implementation has its limitations. For example, there may be bus conflicts (due to a lack of separate dedicated bus), DSP operation conflicts (due to an inability to perform multiple tasks simultaneously), a relatively larger chip size, and a requirement for a higher clock frequency. Due to these limitations, the software-based architecture is often not cost-effective.

An alternative to the software approach is the full hardware approach to decoding MPEG-2 bitstreams. In this case, each functional module of the decoder can be optimized for MPEG-2 decoding. This hardware-based approach has the benefit of a relatively smaller chip size and a lower required operating frequency. However, this architecture has its shortcomings, such as lack of flexibility. In particular, since not all bitstreams are error free, each bitstream requires a unique method of error recovery which may be unavailable with the fully hardware implementation. Additionally, building a purely hardware decoder would result in long design cycles due to the fact that decoding methods are complex and getting it right the first time will most certainly never happen in VLSI.

An MPEG decoding system and method that provides the flexibility of the software-based implementation and has the chip size and operating frequency of the hardware architecture are desirable.

### SUMMARY OF THE INVENTION

A cost-effective MPEG-2 decoder that balances the flexibility of the software and performance of the hardware is presented. An MPEG decoding system and method are described which have several advantages over typical hardware-only or software-only MPEG decoder systems. The architecture of the decoder system in accordance with the invention employs an optimal balance between hardware decoding and software decoding. The balance between hardware and software decoding results in two distinct advantages over the typical pure hardware and pure software decoders that are well known. First, the combination of hardware/software decoding in accordance with the invention allows the flow of the decoding process to be rearranged to accommodate incorrect interpretations of the MPEG-2 specification on the part of those employing MPEG-2 encoders. For example, it is common to see, in some countries, DVD movies that are encoded incorrectly. In the case of a software only decoder, the workaround to accommodate these anomalous DVD disks may require substantially more bandwidth than is available. In the case of a pure hardware decoder, there may not be a workaround available and therefore the disk will be unreadable. With the optimal balance of hardware and software in accordance with the invention, the decoder is able to adapt to improperly encoded data since the software can be updated to handle new problems so that the decoder is more flexible. The cooperation between hardware and software also facilitates workarounds for hardware bugs that would otherwise take years to fix bugs in the hardware system since the analyzing and fixing of hardware bugs at the chip level (in silicon) could easily take more than 1 year.

The MPEG-2 architecture in accordance with the invention employs a pipelined decoder flow. Pipelining the processing is very efficient and alleviates the need to wait for one macroblock of digital data to be decoded completely before processing the next macroblock of data. The cost-effective architecture of the MPEG-2 decoder in accordance with the invention has been successfully integrated as a system on a chip (SOC) solution for DVD decoding systems. A “macroblock,” as used herein, refers to the decoded version of a subset of information that is used to produce a full video image. The size of a macroblock is at least partly a function of the type of information that constitutes the macroblock, and is defined by the MPEG-2 standard. For example, the macroblock size for luminance data may be about 16 pixels×16 pixels. For the color component of the image, the macroblock size may be 8 pixels×8 pixels. Macroblocks are used to facilitate video compression, since it is easier to compress a series of small subsets of data than to compress the full image at once. A person of ordinary skill in the art will understand that macroblocks are typically prepared by slicing up a full image into smaller subsets and encoding each of the subsets by using well-known processes such as motion estimation, discrete cosine transformation, quantization, and variable length encoding.

An apparatus for decoding data is presented, wherein the apparatus includes a bus connected to a main memory unit, hardware modules connected to the bus and configured to execute a decoding process, and a processing unit connected to the bus, wherein the processing unit executes a decoding process by sending programmed signals to the hardware modules and responding to interrupts from the hardware components according to a set of programmed instructions. The instructions are re-programmable. As the hardware modules are configured to execute discrete tasks, the decoding process may be carried out in its entirety by sending signals to the hardware modules in the programmed order.

A method of decoding data by establishing communication with hardware modules that are each configured to execute a discrete task and activating the hardware modules in an order dictated by a computer program is also presented. Each of the hardware modules sends a signal (e.g., an interrupt) upon completing a discrete task, so that a new signal can be sent to another hardware module to perform the next discrete task in the decoding process.

### BRIEF DESCRIPTION OF THE DRAWINGS

FIG. 1 is a diagram illustrating an example of product, such as a DVD player, that may include an MPEG-2 decoder in accordance with the invention;

FIG. 2 is a diagram illustrating more details of the MPEG-2 decoder in accordance with the invention;

FIG. 3 is a diagram illustrating more details of one of the buses of the decoder in accordance with the invention shown in FIG. 2;

FIG. 4 is a diagram illustrating an MPEG-2 video and audio decoding method in accordance with the invention;

FIG. 5 is a diagram illustrating an interrupt driven MPEG-2 video decoding method in accordance with the invention;

FIG. 6 is a diagram illustrating an exemplary interrupt mapping that may be used with the invention;

FIGS. 7A, 7B, and 7C are flowcharts illustrating the interrupt driven video decoding method in accordance with the invention;

FIG. 8 is a diagram illustrating the video decoding method in accordance with the invention which involves both hardware and software decoding in accordance with the invention;

FIG. 9 is a diagram illustrating an interrupt driven MPEG-2 audio decoding method in accordance with the invention;

FIGS. 10A and 10B are a flowchart illustrating the interrupt driven audio decoding method in accordance with the invention;

FIG. 11 illustrates an exemplary memory mapping that may be used with the present invention;

FIG. 12 illustrates an exemplary bitstream that may be processed by the invention; and

FIGS. 13A, 13B, and 13C illustrate a 3:2 pull-down process as performed by the invention.

### DETAILED DESCRIPTION OF A PREFERRED EMBODIMENT

The invention is particularly applicable to MPEG-2 data and DVD disks and it is in this context that the invention will be described. It will be appreciated, however, that the decoder system and method in accordance with the invention has greater utility since the system and method may be used with other types of digital data or other types of media, such as CDs or streaming video data, which contain MPEG-2 data. The decoding system and method in accordance with the invention also may be used with other decoding methods since the balanced hardware and software decoder system may be used for any type of encoded data.

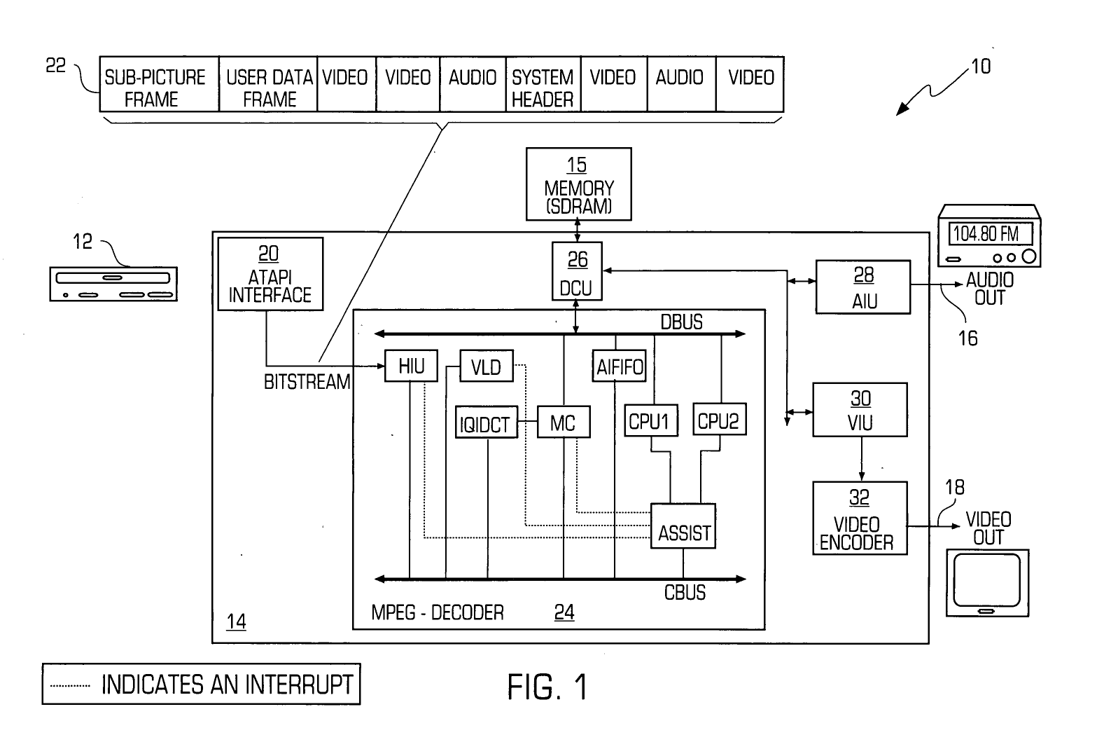

FIG. 1 is a diagram illustrating an example of product 10, such as a DVD player, that may include the MPEG-2 decoding system in accordance with the invention. The product 10 may include an input receptacle 12 for a DVD disk, a decoder unit 14 and memory 15, such as SDRAM. The product may receive digital data from the disk inserted into the input receptacle and may output an audio output stream 16 and a video output stream 18 as is well known. The decoder unit 14 may be one or more semiconductor chips and circuitry. The decoder unit may also include one or more pieces of software, software modules or firmware that are stored in the memory 15. The combination of the hardware circuitry and the firmware/software are used to implement the well known digital data decoding process.

In more detail, the decoder unit 14 may include an advanced technology attachment packet interface (ATAPI) 20 which receives the digital encoded data (a bitstream 22) from the media. The bitstream may include interleaved frames of data as shown in FIG. 1, such as a sub-picture frame, a user data frame, one or more video frames, one or more audio frames and a system header frame. The bitstream 22 may be fed into an MPEG decoder 24 as shown. The decoder unit 14 may further comprise a DRAM control unit (DCU) 26 that is a module that is responsible for SDRAM control and buffer management, an audio interface unit (AIU) 28, a video interface unit (VIU) 30 and a video encoder 32. The audio interface unit is responsible for distributing the decoded audio data in a format that is appropriate for the desired output. For example, the data may comply with the I²S standard (for analog output) or the IEC958 standard (for digital output). The video interface unit is responsible for mixing and filtering the digital video data before the digital data is sent to the video encoder 32. The video interface may include a variety of different video converting methods, such as NTSC to PAL, PAL to NTSC, pan-scan to letterbox, letterbox to pan-scan, etc . . . . In operation, the product shown receives the digital data from a piece of media and outputs data streams which correspond to audio data as well as video data. Now, the MPEG decoder 24 will be described in more detail.

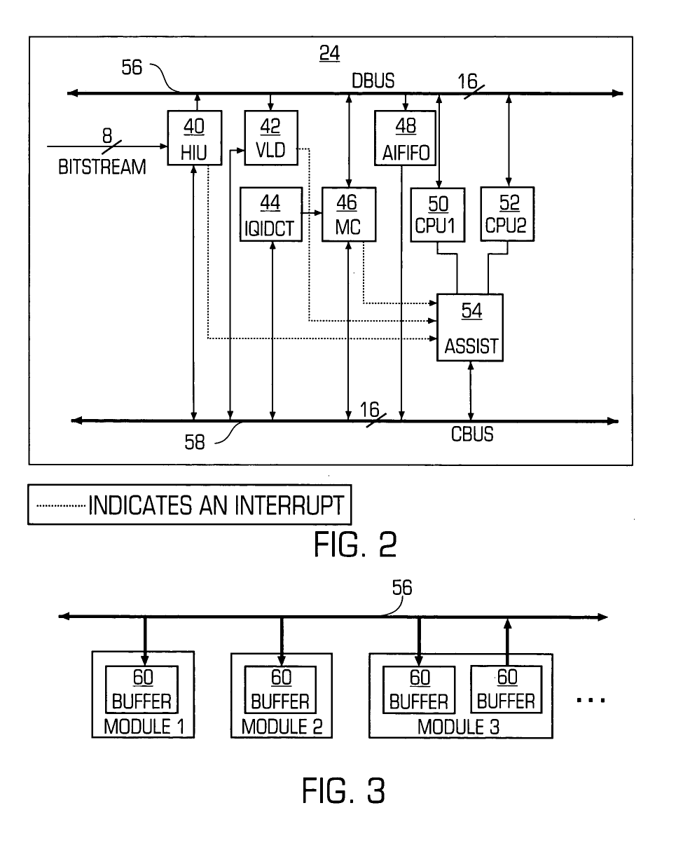

FIG. 2 is a diagram illustrating more details of the MPEG decoder 24 in accordance with the invention. The decoding process typically entails obtaining compressed video data and subjecting them to variable length decoding, inverse-quantization, inverse-discrete cosine transform, and motion compensation to generate a macroblock. The proper macroblocks are eventually combined to construct the full image.

The MPEG decoder comprises a host interface unit (HIU) 40, a variable length decoder (VLD) 42, an inverse quantization and inverse discrete cosine transform unit (IQIDCT) 44, a motion compensation unit (MC) 46, an audio interface FIFO (AIFIFO) 48, a first central processing unit (CPU1) 50, a second central processing unit (CPU2) 52 and an assistant unit (ASSIST) 54 which are connected together by a data bus (DBUS) 56 and a control bus (CBUS) 58. In addition, the elements are interconnected together as shown in FIG. 2. For example, the HIU, VLD and MC may generate interrupts which are fed into the ASSIST unit 54 as shown.

The host interface unit (HIU) 40 is responsible for decrypting and de-multiplexing the MPEG-2 audio/video bitstream. For DVD applications, the input bitstream is often encrypted by CSS (Content Scrambling System) requiring real-time decryption in some cases. The HIU may also convert the 8-bit incoming bitsteam to 16-bit data in order to store the de-multiplexed data into the 16-bit SDRAM 15 as shown in FIG. 1. The variable length decoder (VLD) 42 is responsible for parsing the MPEG-2 video bitstream and decoding the variable length code. The VLD 42 supports all forms of MPEG-1 and MPEG-2 variable length code tables. The motion vectors are also decoded by the VLD 42. The VLD may operate in one of three modes: slave mode, startcode mode, and decoding mode. In slave mode, CPU1 50 performs bit by bit shifts and parses the video data from VLD input buffer using a special instruction. In the startcode mode, VLD will search for a startcode and will generate an interrupt to CPU1 when a startcode is found. In the decoding mode, VLD decodes macroblocks of the video bitstream one by one.

The IQIDCT unit 44 is responsible for the calculation of inverse quantization, arithmetic, saturation, mismatch control, and 2-dimensional (2D) 8×8 inverse discrete cosine transform as are well known. In general, there are two ways to implement a 2D IDCT. One method uses row-column decomposition, while the other uses a 2D direct implementation. We have implemented the row-column decomposition method because it yields a relatively small area in a chip. The motion compensation unit (MC) 46 receives data from the IQIDCT 44 and is responsible for reading reference pictures from SDRAM, performing horizontal and vertical interpolating, and writing the reconstructed pixels into SDRAM. All of the prediction modes for MPEG-2 such as frame-based, field-based, dual prime type and so on are supported.

Both CPU1 50 and CPU2 52 are nearly identical 24-bit RISC-like CPUs with the exception that CPU2 incorporates several DSP functions not found in CPU1. Both CPUs have their own local memory and Direct Memory Access (DMA) engine that is used to transfer block data between SDRAM and local memory. CPU1 is mainly responsible for assisting in video decoding and display control while CPU2 is dedicated for audio decoding. The ASSIST unit 54 is responsible for CBUS read/write arbitration and interrupt routing between the hardware modules and to the two CPUs. The interrupts from the hardware modules can be programmatically mapped to either or both CPUs which increases the decoders flexibility. The AIFIFO 48 obtains block data from SDRAM and outputs the data bit by bit according to setting of control registers. CPU1 or CPU2 can read bit data from this AIFIFO module through CBUS. This function assists in audio decoding by reducing the CPU load demand.

As illustrated in FIG. 2, there are two main buses in the diagram: CBUS 58 and DBUS 56. CBUS is a simple 16-bit control bus through which all control or parameter data is passed. CBUS transactions take two cycles to access a control register. Both the CPUs can access the CBUS through CBUS arbitration logic in the ASSIST module. DBUS 56 is designed to carry block data that is transferred between an external SDRAM and internal hardware modules. This invention supports MPEG-2 decoding at main profile and main level (MP@ML) as well as MPEG-1 decoding. The MPEG-2 decoding algorithm specifies several buffers, including the compressed bitstream buffer and the reference and decoded picture buffer. In order to decode MPEG-2 video streams properly, an external memory is needed to store these buffers. A 16-bit SDRAM is selected for storage in this invention because it offers high-performance and is cost-effective.

FIG. 3 illustrates more details of the DBUS 56 in accordance with the invention. The DBUS 56 is used to transfer data between modules for video decoding, audio decoding, and video display. Modules that need access to the DBUS 56 must first request access to the bus. Once the request is granted and the module has access to the bus, the module performs a bus transfer over the DBUS 56 before releasing the bus. Modules may have more than one type of request, depending on the type of data to be transferred over the DBUS 56. A priority arbiter may grant bus access to multiple bus requests, e.g. 20 types of DBUS requests, in an efficient order by assigning priorities based on request characteristics. For example, requests associated with video data transfers for display purposes are granted the highest priority since the display process requires real-time data transfer. Audio processing requests, on the other hand, may be given a lower priority because the audio decoding process is tolerant of latencies.

In particular, as shown in FIG. 3, every hardware module (such as the hardware modules shown above in FIG. 2) is connected to the DBUS 56. In addition, each hardware module may include a buffer 60, such as a 64×16 FIFO in a preferred embodiment, that stores the data sent to or from the external SDRAM (not shown in FIG. 3). These buffers exist to increase the memory bandwidth efficiency when data is being transferred to or from the external SDRAM since a hardware module is able to retain the data it needs to perform its operations without constantly requesting data from the SDRAM. In addition, the data for a particular hardware module may be transferred between the SDRAM and the particular hardware module as a large block transfer which results in a more efficient use of the memory bandwidth.

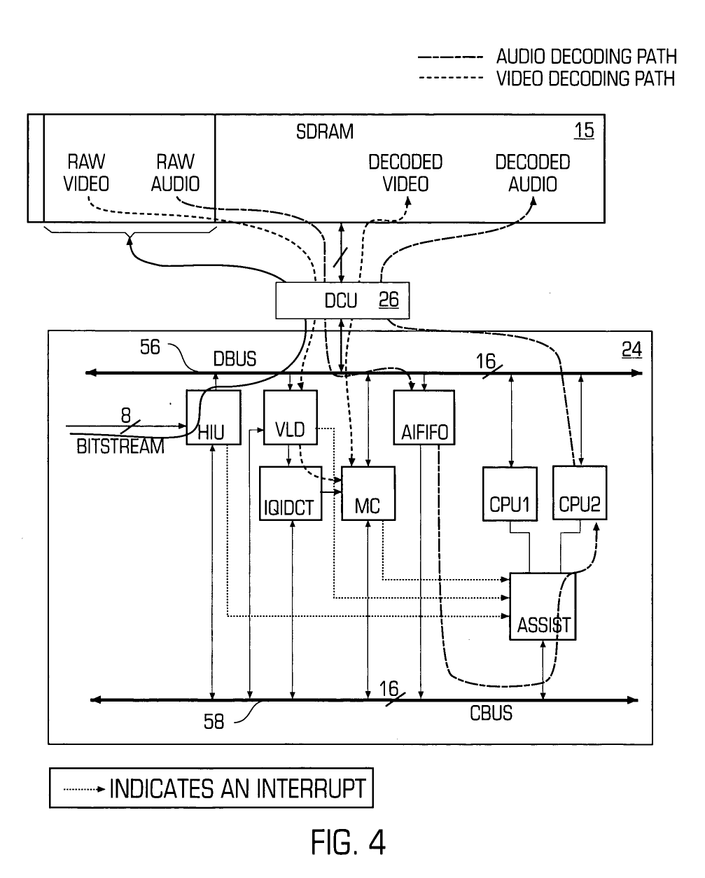

FIG. 4 is a diagram that depicts an interrupt driven simultaneous MPEG-2 video and audio decoding method in accordance with the invention. The decoding process is controlled by interrupt signals sent from different hardware modules shown. For video decoding, CPU150 receives each of the interrupts from the ASSIST module 54, as described below in reference to FIG. 4A. For audio decoding, on the other hand, CPU2 52 receives interrupts from the AIU module 28 (see FIG. 1) as described below. When the input bitstream enters the decoder through HIU 40, it gets stored in the SDRAM 15 via the DCU 26. Depending on whether the data is video data or audio data, the received data is stored in different sections of the SDRAM 15. The decoder pulls data from the appropriate sections of the SDRAM 15 when it executes the decoding process. More specifically, the video data is pulled into the VLD 42 and the audio data is pulled into the AIFIFO 48, as shown by a dotted arrow and a dashed arrow, respectively. The video data is operated on by the IQIDCT 44 and the MC 46 before being returned to yet another section of the SDRAM 15 that is reserved for decoded video data. The audio data, on the other hand, is read by AIFIFO 48 and decoded by CPU2 52. The decoded audio data is then returned to a section of the SDRAM 15 that is reserved for decoded audio data.

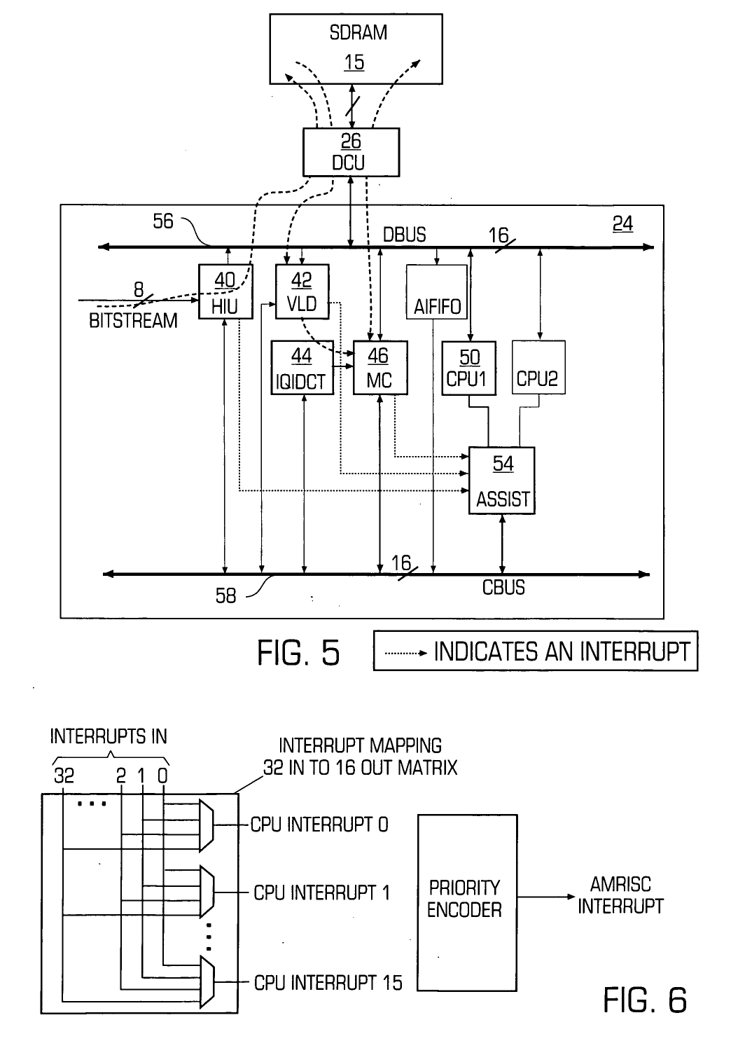

FIG. 5 is a diagram illustrating an interrupt driven MPEG-2 video decoding method in accordance with the invention. In this figure, the hardware modules, such as the HIU 40, the VLD 42, the IQIDCT 44, the MC 46, CPU150, ASSIST 54, DBUS 56 and CBUS 58, that are involved with the video decoding method are shown in normal text and are numbered while the hardware modules that do not participate in the video decoding are shown in phantom and do not have reference numerals. As shown in FIG. 5 and above in FIG. 2, the interrupts from each hardware module are routed through the ASSIST module 54. The ASSIST module 54 decodes and maps the interrupts and passes them on to CPU1 (and CPU2) based on the interrupt's priority.

FIG. 6 illustrates an exemplary interrupt mapping that may be used with the invention. In the embodiment shown, the interrupt mapping includes 32 interrupt sources. The 32 interrupts enter a matrix that selects which of the 32 interrupts are mapped to 16 interrupt signals observable by the AMRISC CPU (CPU1 and/or CPU2). The AMRISC CPU responds to the 16 interrupts based on a priority encoder that prioritizes the 16 interrupts. Up to 16 interrupts may be selected for acknowledgement by CPU1 and/or CPU2. A priority encoder splits the 16 interrupts into four groups, which are given an interrupt priority from zero to three with zero being the highest priority. Priorities are assigned based on the nature of the requesting interrupt, e.g., if it needs to be handled real-time. Generally, interrupts associated with video display (e.g., vertical or horizontal synchronization interrupts) are given higher priority than interrupts associated with audio decoding processes. The priority encoder is fully programmable, and the prioritization method may be adjusted to the particular application as appropriate.

The decoding of MPEG-2 video, in accordance with the invention, is driven by interrupts from different hardware modules as shown. For video decoding, CPU150 receives each of the interrupts from the ASSIST module 54 and will then execute the appropriate service routines according to the type of the interrupt. For example, a VLD interrupt routine performs many tasks including checking the start code, evaluating header parameters and checking the decoder status (e.g., are there any errors). During the decoding process, the VLD interrupt routine determines the decoding status by reading registers in the IQ, IDCT, and MC modules. The status read from these modules is used to indicate the process state and error conditions that exist, if any. In the event the CPU detects errors it considers correctable, it reconfigures the IQ, IDCT, and MC hardware blocks to generate correct data from the incorrect data that is currently in the pipeline. If the CPU detects a fatal error that cannot be corrected, then the CPU resets the IQ, IDCT, and MC blocks to purge the error from the decoding processing.

When the MC process is complete, an MC interrupt is generated to indicate that the completed portion of the image is now stored in SDRAM.

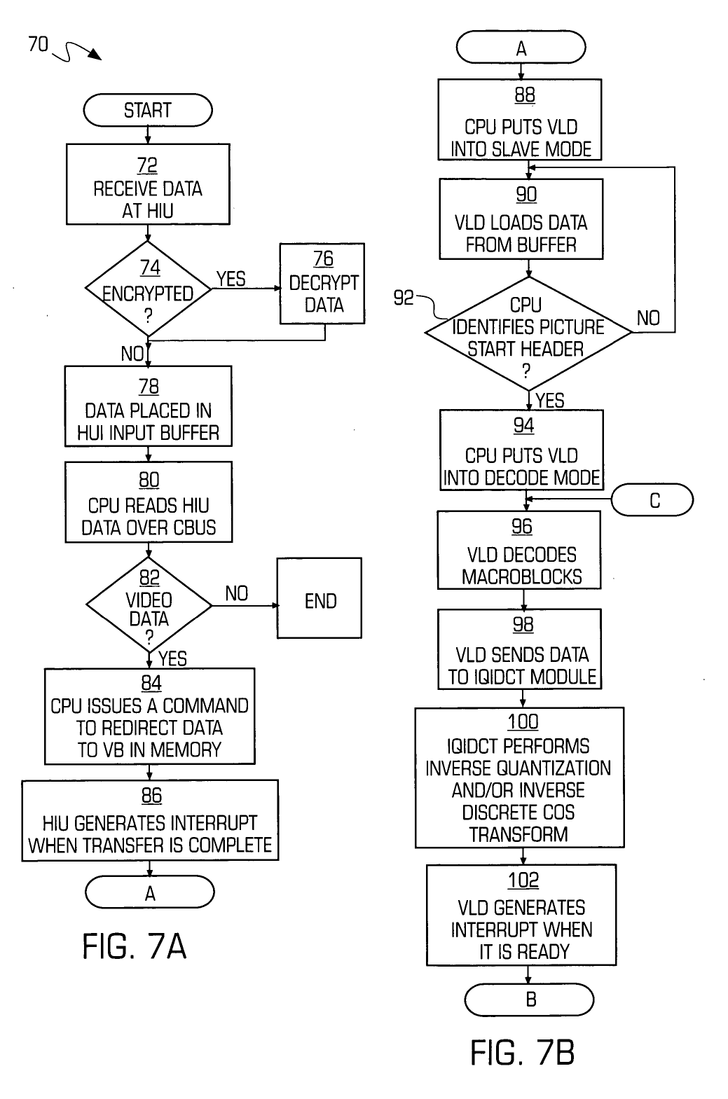

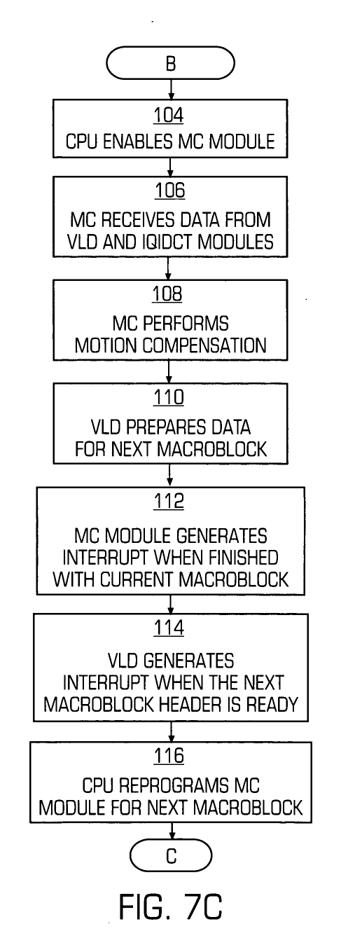

FIGS. 7A, 7B, and 7C are flowcharts illustrating an interrupt driven video decoding method 70 in accordance with the invention. The interrupt driven decoding method will be described with reference to FIG. 5 and FIGS. 7A-7C. The actual video decoding steps are well known in that there are a predetermined set of well known steps, such as variable length decoding (VLD), inverse quantization (IQ), applying an inverse discrete cosine transform (IDCT), and motion compensation (MC) which must occur in order to decode a MPEG datastream. In addition, the hardware shown in FIG. 5 may implement various different decoding steps and is not limited to any particular decoding step. For example, the decoder shown in FIG. 5 may use various different motion compensation steps or various different inverse quantization steps. The novel architecture in accordance with the invention executes those well known decoding steps in a novel manner.

In particular, in the novel architecture in accordance with the invention shown in FIG. 5, MPEG-2 decoding begins when an 8-bit bitstream arrives at the input buffer of the HIU 40 (step 72) as shown in FIG. 7A. In step 74, the HIU determines if the data has been encrypted using CSS. If the bitstream is encrypted by CSS, it is first decrypted in step 76 by the special hardware inside the HIU. The bitstream (decrypted or not) then is placed into the input FIFO of the HIU 40 in step 78. In step 80, as bitstream flows into the HIU's input FIFO, CPU1 reads the input FIFO (over the CBUS) to determine the type of data being sent to the HIU. If CPU1 determines that the data is video packet data in step 82, the CPU issues a command (through the CBUS) in step 84 to the HIU to redirect subsequent raw video data over the DBUS to a video buffer established in the external memory (SDRAM in the example shown). Similarly, if CPU finds audio data in the bitstream, it instructs the HIU to redirect subsequent audio data to an audio buffer established in the external SDRAM. After HIU finishes transferring data to SDRAM, it will generate an interrupt to CPU1 in step 86 and wait for CPU1 to issue a new command.

Once the HIU has placed raw video data in the external SDRAM, the VLD, IQIDCT, MC and CPU1 modules cooperate with each other to decode the raw video data. In particular, the CPU places the VLD into the slave mode in step 88 where the VLD module begins consuming raw video data from the external SDRAM. At the same time, the CPU reads and analyzes the data from the VLD's input buffer as it is filled with raw video data in step 90. Once the CPU locates a picture start header (see step 92), the CPU configures the VLD to operate in decode mode in step 94. In the decode mode, the VLD decodes macroblock information in step 96 and passes the decoded information to the IQIDCT module in step 98 and the IQIDCT module performs quantization in step 100. Once the VLD has decoded the appropriate macroblock header information, the VLD interrupts the CPU in step 102 to indicate that the VLD is holding information relating to the “next” macroblock of data.

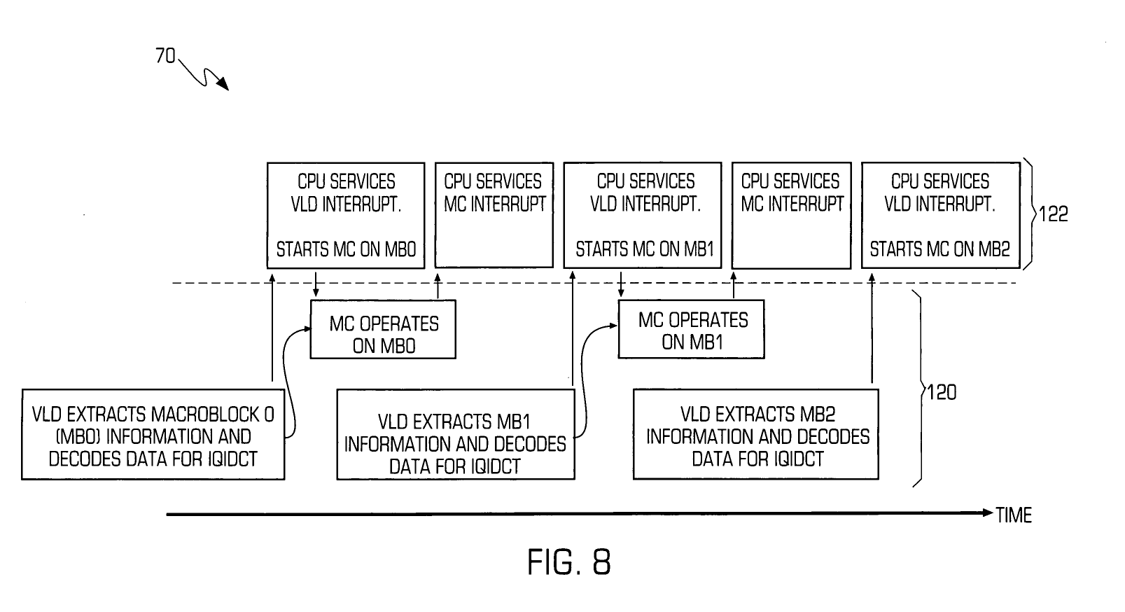

Once the VLD/IQIDCT pipeline has been filled, the CPU enables the MC module in step 104 which consumes the data in the VLD/IQIDCT pipeline. While the MC module performs motion compensation (in steps 106 and 108), the VLD prepares the next macroblock of data for the IQIDCT pipeline in step 110. When the MC module is finished with its task, it interrupts the CPU in step 112 to indicate that it has completed its task for the current macroblock. The CPU then waits for the VLD to interrupt in step 114 indicating it has re-filled the pipeline and has header information for the next macroblock. Once the CPU receives a VLD interrupt, it re-programs the MC module in step 116 based on the “next macroblock” information currently held in VLD and the whole process repeats as the method loops back to step 96. In this manner, each macroblock of the video data may be decoded in accordance with the invention using the interrupt driven decoding. Now, the interrupt driven decoding will be described in more detail with reference to FIG. 8.

FIG. 8 is a diagram illustrating the video decoding method 70 in accordance with the invention which involves both hardware and software decoding in accordance with the invention. FIG. 8 illustrates interaction between hardware modules 120 and software being executed by the CPU 122 during the decoding process over time. For this example, only the interaction of the VLD module, the MC module and the CPU are shown for clarity. Thus, as shown, the VLD module may extract a first macroblock of video data (macroblock 0—MB0) and provide that data to the IQIDCT module as described above. The VLD then interrupts the CPU and the CPU services the interrupt from the VLD by starting the MC module operation. The VLD interrupt is served by CPU and will not be served again until the MC interrupt is served as shown. Likewise, after MC is served by the CPU, it will not be served again until the VLD interrupt is served. Thus, although the CPU serves the VLD interrupt and MC interrupt serially, the VLD, IQIDCT and MC modules operate in a pipelined architecture. In particular, while the MC module is operating on the data for a macroblock, the VLD and IQIDCT are preparing the next macroblock. This pipelining improves the efficiency of the decode process and increases the speed of the decoding process. Now, the audio decoding process in accordance with the invention will be described.

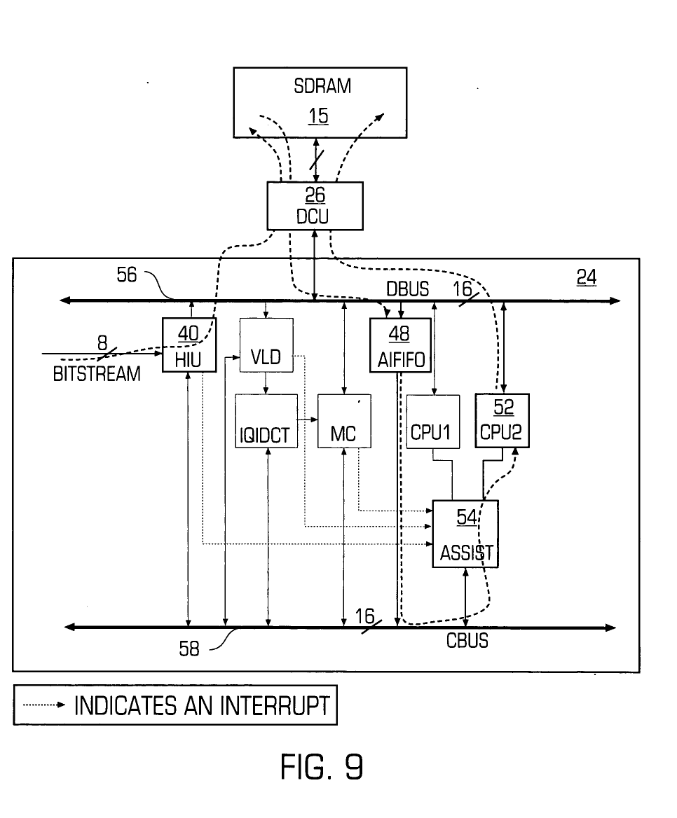

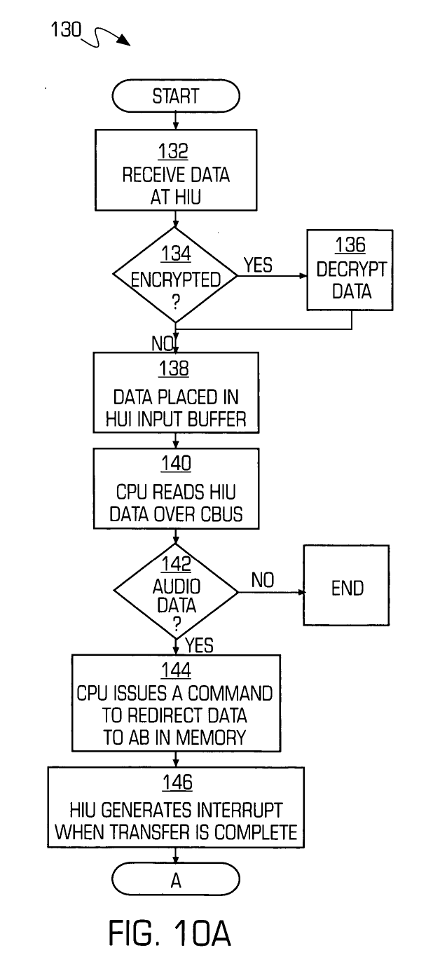

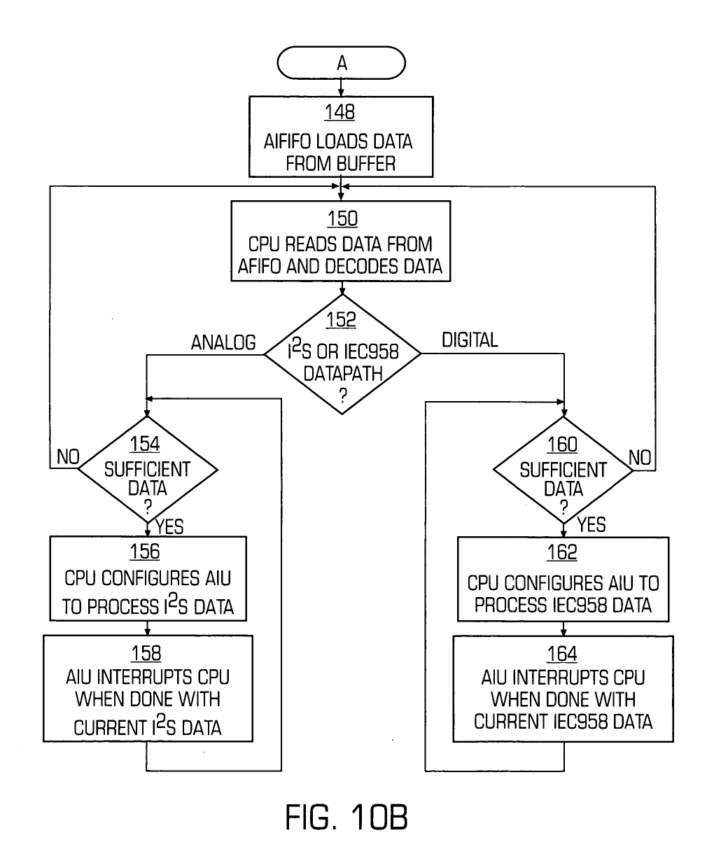

FIG. 9 is a diagram illustrating an interrupt driven MPEG-2 audio decoding method in accordance with the invention and FIGS. 10A and 10B are flowcharts illustrating an interrupt driven video decoding method 130 in accordance with the invention. In FIG. 9, the hardware modules, such as the HIU 40, the AFIFO 48, CPU2 52, ASSIST 54, DBUS 56 and CBUS 58 that are involved with the audio decoding method are shown in normal text and are numbered while the hardware modules that do not participate in the audio decoding are shown in phantom and do not have reference numerals. As shown in FIG. 9, as bitstream data flows into the HIU's input FIFO in step 132. In step 134, the HIU determines if the data has been encrypted using CSS. If the bitstream is encrypted by CSS, it is first decrypted in step 136 by the special hardware inside the HIU. The bitstream (decrypted or not) then is placed into the input FIFO of the HIU 40 in step 138. In step 140, as bitstream flows into the HIU's input FIFO, CPU1 reads the input FIFO (over the CBUS) to determine the type of data being sent to the HIU. If CPU finds audio data in the bitstream (see step 142), it instructs the HIU to redirect subsequent audio data to a raw data audio buffer (AB) established in the external SDRAM in step 144. After HIU finishes transferring data to SDRAM, it will generate an interrupt to CPU in step 146 and wait for the CPU to issue a new command.

Once the AIFIFO module determines that there is data in the raw data audio buffer established in the external SDRAM, AIFIFO begins reading that data in step 148. Using the CBUS to communicate with the AIFIFO, CPU2 reads the raw audio data from AIFIFO, decodes it in step 150, and places the uncompressed decoded audio data back into the external SDRAM into one of two new buffer locations in the external SDRAM. In particular, there are two destination buffers for uncompressed-decoded audio data that is placed in the external SDRAM. One is called the I²S buffer. This buffer is allocated for uncompressed-decoded data suitable for analog output. The other buffer is called the IEC958 buffer. This buffer is used to hold data that will eventually be sent out through the IEC958 digital output. Depending on the output configuration, these two buffers may or may not share the same SDRAM space. Thus, in step 152, the CPU determines the desired output format (digital or analog).

CPU2 is used to control the flow of uncompressed-decoded audio data. When CPU2 determines that there is sufficient uncompressed-decoded audio data in the I2S buffer in step 154, it configures the AIU module (see FIG. 1) in step 156 to begin reading and processing I2S buffer data. Once the AIU has processed a block of I2S data, it interrupts CPU2 in step 158 to indicate it has completed its task. Then, the method loops back to step 154 to decode more analog data. The same procedure applies to the IEC958 buffer. First, CPU2 determines if the IEC958 buffer has data in step 160. If so, CPU2 configures the AIU in step 162 to process IEC958 data. Once the AIU has completed a block of IEC958 data, it interrupts CPU2 in step 164 to indicate it is done. In this manner, the decoding system in accordance with the invention decodes audio data using an interrupt driven method.

As described above, the system has both hardware and software components which work in cooperation with each other to achieve the video and audio decoding described above. The partition between software and hardware described above has been optimized to lower the cost of the overall MPEG-2 decoding system. In the case of MPEG-2 video decoding, the MPEG-2 video is pre-parsed in software by CPU1 since this task requires very little bandwidth. For computationally intensive tasks such as Variable Length Decoding (VLD), Inverse Quantization Inverse Discrete Cosine Transform (IQIDCT) and Motion Compensation (MC), hardware is employed since the hardware is able to handle those tasks more efficiently than a pure software system and may operate in a parallel, pipelined manner. The software component is coupled to the hardware decoding process through interrupts thereby releasing the CPU to perform other tasks when its services are not required by the hardware modules.

In the case of audio decoding, more of the decoding burden is placed on CPU2 through the use of software. Using software to perform audio decoding simplifies the task of supporting the variety of audio standards that exist (AC-3, DTS, MPEG2 audio, . . . ). Additionally, the flexibility afforded by software decoding allows the architecture to quickly embrace new standards that arrive (e.g. MP3, HDCD, WMA, . . . ). The software decoding process is assisted by hardware in the form of AIFIFO which performs the task of gathering data and from the AIU module which formats the uncompressed-decoding data before it is sent out of the chip.

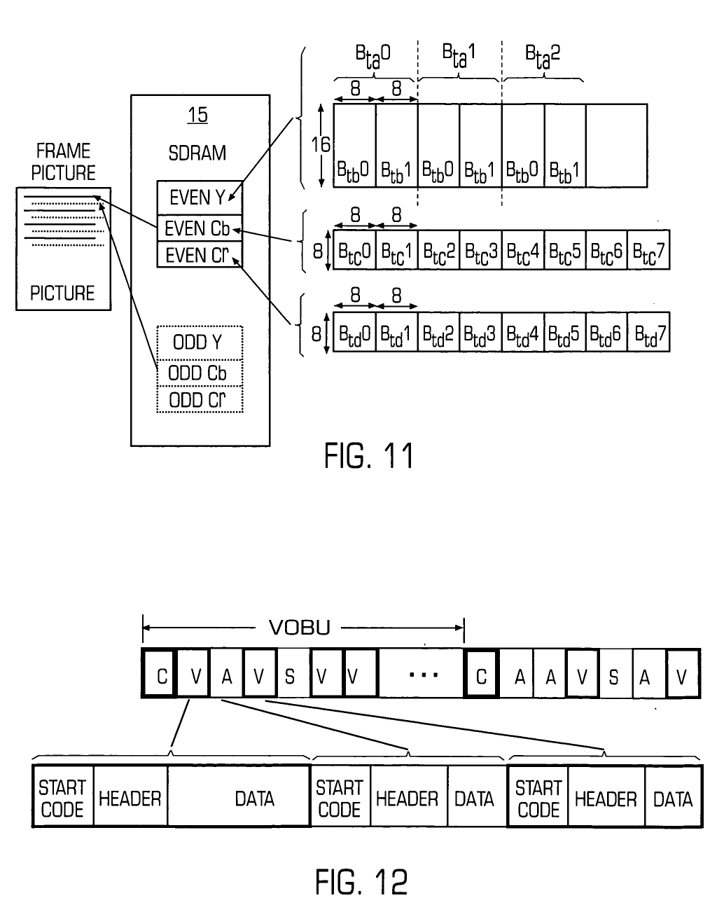

FIG. 11 depicts an exemplary memory mapping that may be used with the invention. One of the first considerations when designing an MPEG-2 decoder is the efficiency of the memory data interface. MPEG-2 decoding involves moving and manipulating large amounts of data. Although DRAMs and SDRAMs are extremely cost efficient storage devices, the large storage area is broken up into smaller blocks designated as banks and pages. Multiple memory accesses within the same page/bank benefit from the highest possible data throughput. Multiple memory accesses that cross a bank or page boundary will incur a multi-cycle penalty, subsequently reducing the overall data bandwidth.

To overcome the limitations imposed by page and bank boundaries, this invention organizes the storage of pictures in the SDRAM to facilitate efficient transfer of picture data in and out of the SDRAM. An MPEG-2 frame picture is constructed from two field pictures called even and odd. The even field contains information representing the even lines of the image. Similarly, the odd field contains the information for describing the odd lines of the image. Each field (even or odd) contains three components called Y, Cb and Cr that describe the luminance (brightness), and chrominance (color) of that field. As illustrated in FIG. 11, the fields are separately mapped into memory. The Y (luminance) component of each field is divided into many 16×16 blocks denoted as Bta[n]. Each 16×16 block of Y data is stored in the SDRAM in an ascending order from Bta0, Bta1, . . . , Bta[n]. As illustrated, each 16×16 block is subdivided into two 8×16 blocks, denoted as Btb0 and Btb1. The Y data is stored for a particular image starting with data from the top left corner of the image: left to right, top to bottom. The storage of chrominance (Cb, Cr) component for the each field is also shown in FIG. 8. The chrominance component of the each field is divided into 8×8 blocks. Each 8×8 block for Cb is stored in the SDRAM as Btc0, Btc1, Btc2, etc. and each 8×8 block for Cr is stored as Btd0, Btd1, Btd2, etc.

Using this special mapping for reference and reconstructed pictures in the SDRAM, the decoder can access the picture data more efficiently because of the characteristics of MPEG-2 algorithm.

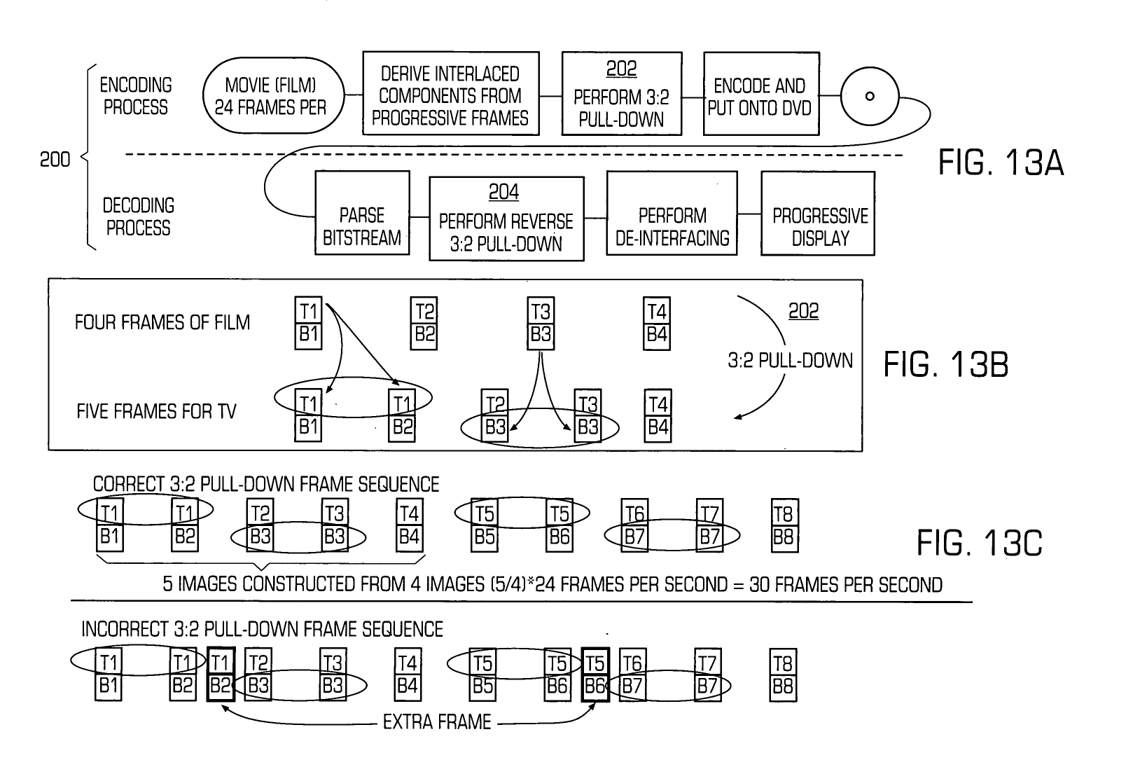

FIGS. 12 and 13A-13C provide examples of errors that well known error detection mechanisms do not detect as well as the invention does.

FIG. 12 illustrates an exemplary bitstream format that may be processed by the invention. As part of the MPEG-2 decoding process, the parser extracts Video Object Units (VOBU) from the bitstream. As illustrated in FIG. 12, a VOBU consists of commands, video, audio, sub-picture, and other data, each of which is identified by a start code, header, and data. In the case of video decoding, the video packets are extracted and passed to the VLD, as described above. The VLD searches the video packets for start codes, which are unique byte sequences that identify a header and the length of data block associated with the header. When the VLD locates a start code, it alerts the internal AMRISC processor which analyzes the start code type and the associated header. Based on the start code type and header information, a variety of events take place.

As shown in FIG. 12, the start code, the header, and the data are contained in adjacent data blocks. However, in some incorrectly encoded disks, random data is present at the borders, for example between a data segment and the following start code segment. The presence of random data at the borders cause misinterpretation of data and ultimately lead to presentation of incorrect video content. The invention, however, allows recovery from an invalid start code by virtue of its mixed software and modular hardware design. Whenever a start code is encountered, the video AMRISC analyzes the start code and header information to determine if it is valid (fits within one of the preselected conditions, e.g., picture type, play status, video configuration). If the start code is determined to be invalid, the video AMRISC resets small sections of hardware within the VLD to purge the error condition and prepare the VLD for the next valid start code. The ability to reset a subset of the hardware without effecting the overall decoding process is useful for correctly recovering from these incorrectly encoded disks.

FIGS. 13A, 13B, and 13C depict an encoding and decoding process 200 including a 3:2 pull-down process 202 and a reverse 3:2 pull-down process 204 that may be performed by the invention. It is well known that frames of filmed movies are stored in progressive format at a rate of 24 frames per second. It is also well known that images on a TV are presented in a different format than the storage format of the filmed movies, such as an interlaced format at a rate of 30 frames per second in the United States. Thus, in order to make a filmed movie suitable for display on a television, a film stored at 24 frames per second is converted to a 30-frame-per-second format through a process that is commonly referred to as a “3:2 pull-down process.” The 3:2 pull-down process 202 is accomplished by duplicating top (T) and bottom (B) fields at certain intervals in the frame sequence. As shown in FIG. 13B, top and bottom fields are independently repeated as a means of adding extra frames to the image sequence. The top and bottom fields are repeated in such as way as to create five images for every 4 original film images. This 4-to-5 conversion ratio converts the frame rate from 24 frames per second to 30 frames per second.

Problems occur when the 3:2 pull-down process is not performed correctly during encoding. For example, some low-quality disks include an additional frame (top and bottom fields) in the bit stream, as shown in FIG. 13C. This additional frame results in six frames being created for every four original frames when only five frames need to be created. The invention recognizes this type of error and is able to turn off the 3:2 reverse pull-down step before de-interlacing and display. This type of “flexibility” is difficult to implement in a pure-hardware system, and requires too much bandwidth for a pure-software implementation to be a viable option.

While the foregoing has been with reference to a particular embodiment of the invention, it will be appreciated by those skilled in the art that changes in this embodiment may be made without departing from the principles and spirit of the invention, the scope of which is defined by the appended claims.

What is claimed is:

1. An apparatus for decoding data, the apparatus comprising:
a bus;
hardware modules connected to the bus and configured to execute a decoding process; and
a processing unit connected to the bus, wherein the processing unit executes a decoding process by sending programmed signals to the hardware modules and responding to interrupts from the hardware components according to a set of programmed instructions.

2. The apparatus of claim 1 further comprising a second bus connected to the processing unit and at least one of the hardware modules.

3. The apparatus of claim 1, wherein the hardware modules comprise:
at least one hardware unit that decodes video data according to a video decoding method programmed into the processing unit; and
at least one audio hardware unit that decodes audio data according an audio decoding method programmed into the processing unit.

4. The apparatus of claim 3, wherein the hardware modules retrieve audio data from the main memory unit before decoding.

5. The apparatus of claim 1, wherein the hardware modules comprise:
a transformation unit that transforms the video data into pixel data; and
a motion compensation unit that performs interpolations using the pixel data and reference data from the main memory unit to create a reconstructed image.

6. The apparatus of claim 1 further comprising an interface unit that receives compressed MPEG data, wherein the hardware modules comprise a variable length decoder unit that performs partial decompression of the bitstream.

7. The apparatus of claim 6, wherein the variable length decoder unit sends an interrupt to the processing unit upon finding a startcode which triggers the decoding method.

8. The apparatus of claim 1, wherein the processing unit executes the decoding process by serially activating certain ones of the hardware modules in accordance with a computer program.

9. The apparatus of claim 1, wherein the processing unit comprises a first processor and a second processor, wherein the interrupt is programmatically mapped to at least one of the first and the second processors.

10. The apparatus of claim 9 further comprising:
a local memory unit for the first processor; and
an engine for transferring data between the main memory unit and the local memory unit.

11. The apparatus of claim 9, wherein the first processor is configured to handle video decoding and display control and the second processor is configured to handle audio decoding.

12. The apparatus of claim 1, wherein the main memory unit stores video data and audio data separately.

13. The apparatus of claim 1 further comprising a host interface unit that receives video and audio data, parses the data, and stores the video and audio data in the main memory unit.

14. The apparatus of claim 1 further comprising an Assist hardware unit that receives interrupts generated by the hardware modules and forwards the interrupts to the processing unit.

15. The apparatus of claim 14, wherein the Assist unit stores an arbitration scheme for the hardware modules.

16. The apparatus of claim 15, wherein the arbitration scheme comprises prioritization of video data transfers over audio data transfers.

17. The apparatus of claim 1 wherein the decoding process comprises variable length decoding, inverse quantization, inverse discrete cosine transform, and motion compensation that are executed by the different hardware modules in response to separate signals from the processing unit.

18. The apparatus of claim 1, wherein the processing unit determines a decoding status, evaluates header parameters and checks for errors.

19. The apparatus of claim 18, wherein the processing unit reads registers in different hardware modules, the registers indicating a current process state and presence of any errors.

20. The apparatus of claim 19, wherein the processing unit reconfigures the hardware modules to generate correct data from incorrect data.

21. The apparatus of claim 20, wherein the processing unit purges the error from the decoding process upon determining that the error is incorrigible.

22. The apparatus of claim 1, wherein an interrupt from a hardware module in charge of motion compensation indicates that the decoding process is completed for a portion of an image.

23. The apparatus of claim 1, wherein the processing unit sends signals to the hardware modules in an order dictated by a computer program, and wherein the decoding process is changeable by modification of the computer program.

24. The apparatus of claim 1, wherein the hardware modules decode motion vectors in the data.

25. The apparatus of claim 1, wherein the hardware modules perform data transformation by one of inverse quantization, arithmetic, saturation, mismatch control, and two-dimensional inverse discrete cosine transform.

26. The apparatus of claim 25, wherein the two-dimensional inverse discrete cosine transform includes at least one of row-column decomposition and two-dimensional direct implementation.

27. The apparatus of claim 1 further comprising a buffer associated with each of the hardware modules.

28. The apparatus of claim 1, wherein the main memory unit is divided into cells according to a luminance indicator and a chrominance indicator of a field in a data frame.

29. The apparatus of claim 1, wherein the apparatus is integrated as a system-on-chip system.

30. The apparatus of claim 1, wherein the decoding process comprises interrupt signals generated by different hardware modules as each of the hardware modules completes its task.

31. The apparatus of claim 1, wherein the hardware modules comprise components for decrypting input data.

32. An apparatus for video and audio decoding, the apparatus comprising:
a data bus;
hardware modules connected to the data bus, each of the hardware modules being configured to perform a discrete task; and
a processing unit connected to the data bus, wherein the processing unit executes a decoding process by activating the hardware modules in an order dictated by a computer program, and wherein the decoding process is changeable by modifying the computer program.

33. A method of decoding data, the method comprising:
establishing communications with a plurality of hardware modules, wherein each of the hardware modules is configured to perform a discrete task; and
activating the hardware modules in an order dictated by a computer program to execute a decoding process.

34. The method of claim 33 further comprising:
determining a type of an input data;
identifying audio data in the input data;
identifying video data in the input data; and
directing the video input data to a video hardware component that is designed to process video data and directing the audio data to an audio hardware component that is designed to process audio data.

35. The method of claim 33 further comprising:
determining a type of an input data;
identifying audio data in the input data;
identifying video data in the input data; and
sending the video signal to one of the hardware modules to store the input data in a video storage area and sending the audio signal to an audio storage area.

36. The method of claim 33 further comprising sending a signal to one of the hardware modules to decrypt an input data stream.

37. The method of claim 33, wherein the decoding process comprises:
extracting header information for a macroblock of the input data;
converting the macroblock into pixel data; and
generating a reconstructed image based on the pixel data by using motion compensation, wherein a motion compensation module that executes the motion compensation is reprogrammable for each macroblock.

38. The method of claim 37, wherein the decoding process comprises retrieving data from a memory unit that is subdivided into sections according to luminance and chrominance.

39. The method of claim 33, wherein the decoding process comprises prioritizing video data transfers over audio data transfers.

40. The method of claim 33, wherein the decoding process comprises one or more of variable length decoding, inverse quantization, inverse discrete cosine transform, and motion compensation that are executed by the different hardware modules in response to separate signals.

41. The method of claim 33, wherein different hardware modules process different macroblocks of data simultaneously.

42. The method of claim 33 further comprising determining a decoding status and checking for errors.

43. The method of claim 42 further comprising reconfiguring the hardware modules to generate a correct data from an incorrect data that is currently being processed, if an error is present.

44. The method of claim 43 further comprising purging the error from the decoding process upon determining that the error is incorrigible.

45. The method of claim 33, wherein the decoding process comprises decrypting input data.

46. A method of decoding data, the method comprising:
identifying a macroblock of data; and
sending a signal to a second hardware module to perform a second decoding process on the macroblock after receiving an interrupt from a first hardware module, the interrupt indicating completion of a first decoding process on the macroblock.

47. The method of claim 46, wherein the first hardware module comprises a variable length decoder unit that decodes the macroblock's header information and a transformation unit that quantizes the macroblock's data, and the second hardware module comprises a motion compensation unit.

48. The method of claim 46, wherein the first hardware module processes another macroblock while the second hardware module is processing the macroblock.

49. The method of claim 46 further comprising decompression of the macroblock.

50. An apparatus for decoding data, the apparatus comprising:
a bus;
hardware modules connected to the bus and configured to execute a decoding process;
a processing unit connected to the bus; and
computer-readable instructions for the processing unit, wherein the computer-readable instructions map out which signals to issue in response to interrupts from the hardware modules.
